(19) United States
(12) Patent Application Publication
(10) Pub. No.: US 2012/0240078 A1
(43) Pub. Date: Sep. 20, 2012

(54) SYNCHRONIZATION METHOD BETWEEN TWO ELECTRONIC DEVICES INSTALLED ON THE SAME OPERATION SYSTEM

(75) Inventor: Gary KUNG, Santa Ana, CA (US)

(73) Assignee: I O INTERCONNECT, LTD., Santa Ana, CA (US)

(21) Appl. No.: 13/232,993

(22) Filed: Sep. 14, 2011

Related U.S. Application Data
(60) Provisional application No. 61/453,595, filed on Mar. 17, 2011.

(51) Int. Cl. G06F 3/048

(52) U.S. Cl. 715/781

(57) ABSTRACT

An embodiment of the invention provides a synchronization method between a first portable device and a second portable device. The synchronization method comprises determining whether a first operating system of the first portable device is the same as a second operating system of the second portable device. When the first operating system is the same as the second operating system, the first portable device performs a first synchronization procedure to synchronize with the second portable device. Also, a first window on a first desktop of the first portable device is created, wherein the first window contains data, files or application programs currently shown on a second display of the second portable device.

### CROSS REFERENCE TO RELATED APPLICATIONS

This application claims the benefit of U.S. Provisional Application No. 61/453,595 filed Mar. 17, 2011, the entirety of which is incorporated by reference herein. OR

### BACKGROUND OF THE INVENTION

1. Field of the Invention

The present disclosure provides a synchronization method between two electronic devices installed on the same operation system.

2. Description of the Related Art

With the growth of the usage of the portable device, a problem has been raised. The problem is, “how should one simplify the synchronization procedure between two portable devices?” One solution is to directly connect two portable devices to a computer and the portable devices would then synchronize with each other via the computer and other required software and hardware. But the conventional synchronization mechanism is not convenient for users, especially when no computer is available for the synchronization procedure. Therefore, it is desirable to provide a synchronization method that can provide a simple way for synchronizing content between two portable devices.

### BRIEF SUMMARY OF THE INVENTION

An embodiment of the invention provides a synchronization method between a first portable device and a second portable device. The synchronization method comprises determining whether a first operating system of the first portable device is the same as a second operating system of the second portable device. When the first operating system is the same as the second operating system, the first portable device performs a first synchronization program to synchronize with the second portable device. Also, a first window on a first desktop of the first portable device is created, wherein the first window contains data, files or application programs currently shown on a second display of the second portable device.

Another embodiment of the invention provides a portable device that can directly synchronize with portable devices with the same operating system. The portable device comprises a detection device, a controller and a synchronization device. The detection device detects whether the portable device has been connected to a second portable device. When the detection device detects that the portable device has been connected to the second portable device, the detection device outputs a detection signal. The controller receives the detection signal and determines whether a first operating system of the portable device is the same as a second operating system of the second portable device. The synchronization device synchronizes the portable device with the second portable device when the first operating system is the same as the second operating system.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the proposed synchronization mechanism between two electronic devices.

FIG. 2 is a flowchart of a synchronization method between two portable devices according to an embodiment of the invention.

FIG. 3 is a schematic diagram of a portable device with the proposed synchronization mechanism according to an embodiment of the invention.

FIG. 4 shows a desktop of a portable device according to an embodiment of the invention.

FIG. 5 is a schematic diagram showing a synchronization mechanism between two electronic devices according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

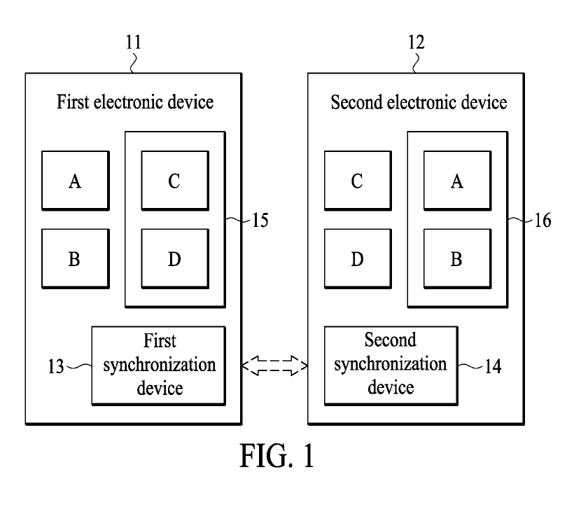

FIG. 1 is a schematic diagram showing a synchronization mechanism between two electronic devices according to an embodiment of the invention. The first electronic device 11 and the second electronic device 12 have the same operation system. The first electronic device 11 may be a tablet, a smart phone, a personal computer, a computer, a PDA, a GPS navigation device or other electronic device. The first electronic device 11 comprises a first synchronization device 13 and the second electronic device 12 comprises a second synchronization device 14. When the first synchronization device 13 synchronizes with the second synchronization device 14, a first window 15 is generated and shown on the display of the first electronic device 11. In other words, the first window 15 is created on a desktop of the first electronic device 11. The first window 15 shows the current status of the second electronic device 12. For example, if the display of the second electronic device 12 currently shows a desktop of the operation system, the window 15 shows the desktop of the operation system of the second electronic device 12. In the second electronic device 12, a second window 16 is generated and shown on the display of the second electronic device 12. The second window 16 shows the current status of the first electronic device 11. For example, if the display of the first electronic device 11 currently shows a desktop of the operation system, the window 16 shows the desktop of the operation system of the first electronic device 11.

In FIG. 1, the display of the first electronic device 11 shows a desktop containing files A and B, therefore, the second window 16 shows files A and B. The display of the second electronic device 12 shows files C and D, therefore, the first window shows files C and D. It is noted that when the first window 15 shows files C and D, the files C and D are transmitted and stored in the first electronic device 11. Similarly, when the second window 16 shows files A and B, the files A and B are in fact stored in the second electronic device 12. In another embodiment, the first window 15 shows only the icons of the files C and D, and the files C and D are stored in the first electronic device 11 only when required by the user.

Furthermore, the user of the first electronic device 11 can directly control the second electronic device 12 via the first window 15. In one embodiment, an application program is installed on the second electronic device 12s, but not installed on the first electronic device 11. The user of the first electronic device 11 can execute the application program via the first window 15. Moreover, the user of the first electronic device 11 may use the application program to process the data stored in the first electronic device. In another embodiment, if the user of the first electronic device 11 wants to share a file with the user of the second electronic device 12, the user of the first electronic device 11 can directly drag the file to the first window 15.

The first synchronization device 13 continuously scans a specific area to determine whether there is a synchronization device 14 within the coverage of the first electronic device 11. Once the first synchronization device 13 detects the second electronic device 12, the first synchronization device 13 first determines whether the operation system of the second electronic device 12 is the same as the operation system of the first electronic device 11. If yes, the first synchronization device may perform at least one step of a handshaking procedure, a connecting procedure, a verification procedure, a security confirmation procedure or other procedure. The first synchronization device 13 may be implemented by hardware or an application program executed by a processor of the first electronic device 11. The communication between the first synchronization device 13 and the second synchronization device 14 can be achieved via wired or wireless interface, such as a wireless network, a Wi-Fi, Bluetooth or other wireless communication interfaces.

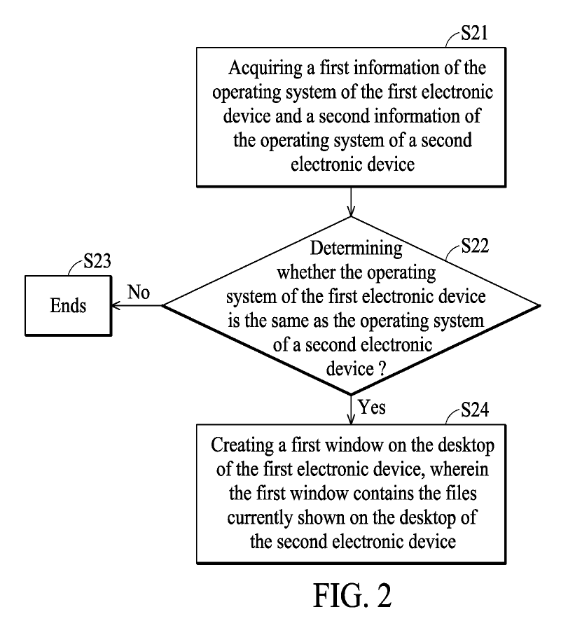

FIG. 2 is a flowchart of a synchronization method between two portable devices according to an embodiment of the invention. In step S21, a synchronization device of a first electronic device first acquires a first information of the operating system of the first electronic device and a second information of the operating system of a second electronic device. Then, the synchronization device determines whether the operating system of the first electronic device is the same as the operating system of a second electronic device (step S22). If not, the synchronization method ends (step S23). If yes, the method goes to step S24 and the first electronic device creates a first window on the desktop of the first electronic device, wherein the first window contains the files currently shown on the desktop of the second electronic device. Then, in step S24, the second electronic device creates a second window on the desktop of the second electronic device, wherein the second window contains the files currently shown on the desktop of the first electronic device. It is noted that the steps S23 and S24 can be executed at the same time. The user of the first electronic device can directly control the second electronic device via the first window. In one embodiment, an application program is installed in the second electronic device installs, but not in the first electronic device. The user of the first electronic device can execute the application program via the first window 15. Moreover, the user of the first electronic device 11 may use the application program to process the data stored in the first electronic device.

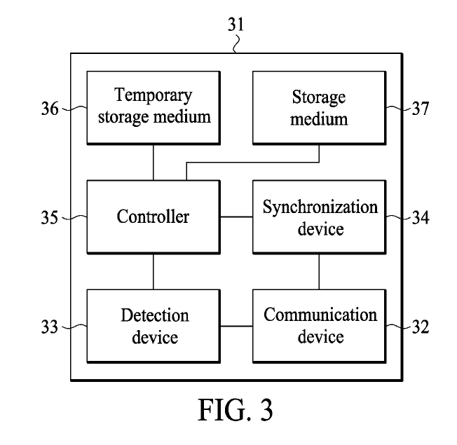

FIG. 3 is a schematic diagram of a portable device with the proposed synchronization mechanism according to an embodiment of the invention. The portable device 31 automatically detects and synchronizes with other portable devices via wireless communication protocols or wired communication protocols. The communication device 32 connects and communicates with other portable devices. In a wireless situation, the communication device 32 may be a WiFi module, a WiMAX module, a Bluetooth module or other similar devices. In a wired situation, the communication device 32 may be replaced by a socket, such as a USB socket, for connecting to another portable device. The detection device 33 is coupled to the communication device 32 and monitors or detects whether the communication device 32 has connected to another portable device. When the detection device 33 detects that the portable device 31 has been connected to a first portable device, the controller 35 determines whether the first operating system of the first portable device is the same as the operating system of the portable device 31. If the controller 35 determines that the first operating system is the same as the operating system of the portable device 31, the synchronization device 34 directly synchronizes with the first portable device. If the controller 35 determines that the first operating system is not the same as the operating system of the portable device 31, the synchronization device 34 may not synchronize with the first portable device or executes another synchronization software to synchronize with the first portable device, wherein the synchronization software is specified for the synchronization between two different operating systems.

In another situation, the synchronization device 34 may comprise two different synchronization procedures, wherein one is for the portable device with the same operating system, and another is for the portable device with a different operating system. The synchronization device 34 may be implemented by hardware or software. Furthermore, the synchronization device 34 can be an application program installed in the portable device. When the portable device 31 wants to synchronize with a first portable device which doesn't have the synchronization application program installed therein, the portable device 31 can transmit the synchronization application program to the first portable device via general purpose communication protocols, wired or wireless communication protocols. When the first portable device has installed the synchronization application program, the portable device 31 can then synchronize with the first portable device by the previously described synchronization mechanism.

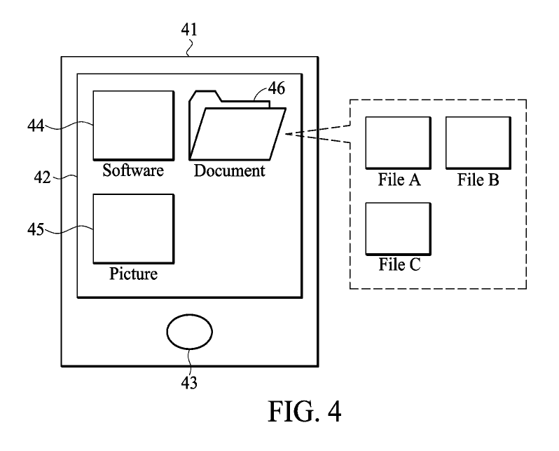

When the synchronization device 34 synchronizes with the first portable device, the synchronization device 34 acquires and duplicates the data, files or program shown on the desktop of the first portable device. Please refer to FIG. 4 for further illustration. FIG. 4 shows a desktop of a portable device according to an embodiment of the invention. The first portable device 41 comprises a display 42 and an input button 43 for controlling the first portable device 41. In this embodiment, the display 42 may comprise a capacitive touch panel, a resistive touch panel or projected capacitance touch panel. In FIG. 4, the display 42 shows a software 44, a picture 45 and a document 46, wherein the document 46 contains files A, B and C. When the synchronization device 34 synchronizes with the first portable device, the synchronization device 34 first creates and shows a synchronization window in the display device of the portable device 31, and duplicates and stores the software 44, the picture 45 and the document 46 in the temporary storage medium 36. It is noted that the synchronization device 34 may not only duplicate and store the icon of the document 46 in the temporary storage medium 36, but otherwise duplicate and store the icon of the document 46 and the contained files A, B and C in the temporary storage medium 36. The user of the portable device 31 can directly access the data of the first portable device 41 via the synchronization window, and all required data for the user to access the first portable device 41 is stored in the temporary storage medium 36 until the user drags and drops the item from the synchronization window to the desktop of the portable device 31. When the item is dragged and dropped to the desktop of the portable device 31, the item is then stored in the storage medium 37. The difference between the operations of the temporary storage medium 36 and the storage medium 37 is the data stored in the temporary storage medium 36 will be automatically deleted or cleared when the synchronization procedure is finished, or the portable device 31 is turned off or reset. However, the data stored in the storage medium 37 is only deleted or cleared manually by the user.

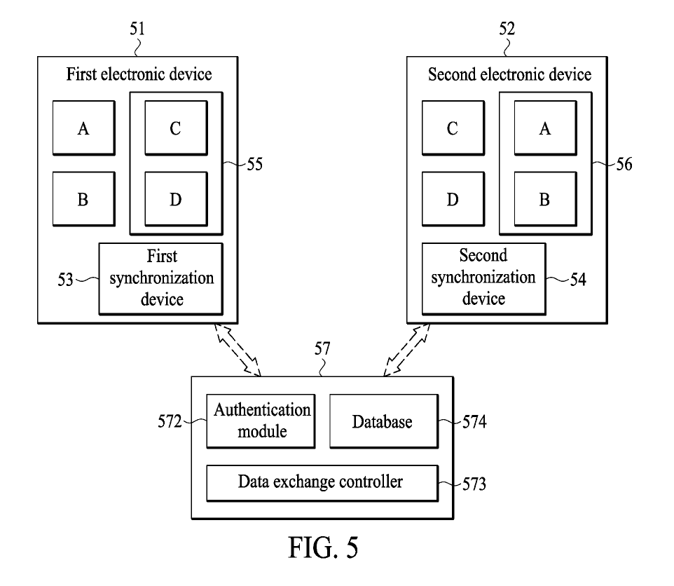

FIG. 5 is a schematic diagram showing a synchronization mechanism between two electronic devices according to an embodiment of the invention. Compared with the synchronization mechanism shown in FIG. 1, the synchronization mechanism is implemented via a third party, such as the synchronization center 57. In this embodiment, the synchronization procedure is implemented only when the operating system of the first portable device 51 is the same as the operating system of the second portable device 52, and the operating system of the third party, such as the synchronization center 57, is compatible with the operating system of the first portable device 51 or the second portable device 52. The first portable device 51 and the second portable device 52 first synchronize with the synchronization center 57, and after synchronization, the data, items, application programs, pictures or other elements shown on the desktop of the first portable device 51 and the second portable device 52 are stored in the database 571. Once the content of the first portable device 51 is changed, the first portable device 51 synchronizes with the synchronization center 57 when the network connection between the first portable device 51 and the synchronization center 57 is available. Similarly, once the content of the second portable device 52 is changed, the second portable device 52 synchronizes with the synchronization center 57 when the network connection between the second portable device 52 and the synchronization center 57 is available.

After the first portable device 51 and the second portable device 52 synchronize with the synchronization center 57, the synchronization center 57 transmits a first authentication data to the first portable device 51 and a second authentication data to the second portable device 52. When the user of the first portable device 51 wants to synchronize with the second portable device 52, the first synchronization device 53 first synchronizes with the second synchronization device 54 to exchange the authentication data. Once the users of the first portable device 51 and the second portable device 52 agree to the synchronization procedure, the first synchronization device 53 and the second synchronization device 54 therefore can exchange the authentication data. Then, the first portable device 51 and the second portable device 52 transmit the first authentication data and the second authentication data to the authentication module 572 to get the authority right to access the data of the second portable device 52 and the first portable device 51 that are stored in the database 571. After the authority right of the first portable device 51 and the second portable device 52 are granted, the data exchange controller 573 then transmits the requested data to the first portable device 51 and the second portable device 52 respectively.

When the first portable device 51 synchronizes with the second portable device 52, a first window 55 is generated and shown on the display of the first portable device 51. The first window 55 shows the current status of the second portable device 52. For example, if the display of the second portable device 52 currently shows a desktop of the operation system, the window 55 shows the desktop of the operation system of the second portable device 52. In the second portable device 52, a second window 56 is generated and shown on the display of the second portable device 52. The second window 56 shows the current status of the first portable device 51. For example, if the display of the first portable device 51 currently shows a desktop of the operation system, the window 16 shows the desktop of the operation system of the first portable device 51.

In FIG. 5, the display of the first portable device 51 shows a desktop containing files A and B, therefore, the second window 56 shows files A and B. The display of the second portable device 52 shows files C and D, therefore, the first window 55 shows files C and D. It is noted that when the first window 55 shows files C and D, the files C and D are transmitted and stored in the first portable device 51. Similarly, when the second window 56 shows files A and B, the files A and B are in fact already stored in the second portable device 52. In another embodiment, the first window 55 shows only the icons of the files C and D, and the files C and D are stored in the first portable device 51 only when required by the user.

Furthermore, the user of the first portable device 51 can directly control the second portable device 52 via the first window 55. In one embodiment, an application program is installed on the second portable device 52, but not installed on the first portable device 51. The user of the first portable device 51 can execute the application program via the first window 55. Moreover, the user of the first portable device 51 may use the application program to process the data stored in the first portable device 51. In another embodiment, if the user of the first portable device 51 wants to share a file to the user of the second portable device 52, the user of the first portable device 51 can directly drag the file to the first window 15.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A synchronization method between a first portable device and a second portable device, comprising:
determining whether a first operating system of the first portable device is the same as a second operating system of the second portable device;
when the first operating system is the same as the second operating system, the first portable device performs a first synchronization program to synchronize with the second portable device; and
creating a first window on a first desktop of the first portable device, wherein the first window contains data, files or application programs currently shown on a second display of the second portable device.

2. The method as claimed in claim 1, wherein when the first operating system is not the same as the second operating system, a second synchronization program that is used for the synchronization between two different operating systems is executed.

3. The method as claimed in claim 1, wherein the data, the files or the application programs shown in the first window are stored in the first portable device after the first window is created.

4. The method as claimed in claim 1, wherein the data, the files or the application programs are stored in a temporary storage device of the first portable device.

5. The method as claimed in claim 4, wherein a first item of the data, the files and the application programs is stored in a storage device of the first portable device when the first item is dragged from the first window to the first desktop of the first portable device.

6. The method as claimed in claim 4, wherein the data, the files and the application programs stored in the temporary storage device are deleted when the first portable device is reset, restarted or the first portable device stops synchronizing with the second portable device.

7. The method as claimed in claim 1, wherein a first application program shown in the first window can be executed to process a first data stored in the first portable.

8. The method as claimed in claim 1, further comprising:
acquiring a first information of the first operating system of the first electronic device; and
acquiring a second information of the second operating system of a second electronic device.

9. A portable device, comprising:
a detection device to detect whether the portable device has been connected to a second portable device and when the detection device detects that the portable device has been connected to the second portable device, the detection device outputs a detection signal;
a controller receiving the detection signal and determining whether a first operating system of the portable device is the same as a second operating system of the second portable device; and
a synchronization device to synchronize the portable device with the second portable device when the first operating system is the same as the second operating system.

10. The portable device as claimed in claim 9, when the portable device synchronizes with the second portable device, the controller creates a first window on a first desktop of the portable device, wherein the first window contains data, files or application programs currently shown on a second display of the second portable device.

11. The portable device as claimed in claim 10, further comprising a temporary storage device for storing data, files or application programs.

12. The portable device as claimed in claim 11, further comprising a storage device, wherein when a first item of the data, the files and the application programs is dragged from the first window to the first desktop of the first portable device, the first item is moved from the temporary storage device to the storage device, and is then stored in the storage device.

13. The portable device as claimed in claim 11, wherein when the portable device is reset, restarted, turned off or the portable device stops synchronizing with the second portable device, the data, the files and the application programs stored in the temporary storage device are then deleted.
